(19) United States
(12) Patent Application Publication
(10) Pub. No.: US 2003/0139926 A1
(43) Pub. Date: Jul. 24, 2003

(54) Method and system for joint optimization of feature and model space transformation of a speech recognition system

(76) Inventors: Ying Jia, Bei Jing (CN); Xiaobo Pi, Bei Jing (CN); Yonghong Yan, Beaverton, OR (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/056,533

(22) Filed: Jan. 23, 2002

(51) Int. Cl. G10L 15/12

(52) U.S. Cl. 704/236

(57) ABSTRACT

Methods for processing speech data are described herein. In one aspect of the invention, an exemplary method includes receiving a speech data stream, performing a Mel Frequency Cepstral Coefficients (MFCC) feature extraction on the speech data stream, optimizing feature space transformation (FST), optimizing model space transformation (MST) based on the FST, and performing recognition decoding based on the FST and the MST, generating a word sequence. Other methods and apparatuses are also described.

### FIELD OF THE INVENTION

The invention relates to pattern recognition. More particularly, the invention relates to joint optimization of feature space and acoustic model space transformation in a pattern recognition system.

### BACKGROUND OF THE INVENTION

Linear Discriminant Analysis (LDA) is a well-known technique in statistical pattern classification for improving discrimination and compressing the information contents of a feature vector by a linear transformation. LDA has been applied to automatic speech recognition tasks and resulted in improved recognition performance. The idea of LDA is to find a linear transformation of feature vectors X from an n-dimensional space to vectors Y in an m-dimensional space (m<n), such that the class separability is maximumized.

There have been many attempts to overcome the problem of compactly modeling data where the elements of a feature vector are correlated with one another. They may be split into two classes, feature space and model space schemes. Both feature space and model space need to be optimized during the speech recognition processing. A conventional approach is to optimize the feature and model space separately. The optimization of feature space and model space are not correlated each other. As a result, the accuracy is normally not satisfied and the procedures tend to be complex. Accordingly, it is desirable to have an improved method and system to achieve high accuracy, while the complexity of the procedure is reasonable.

### BRIEF DESCRIPTION OF THE DRAWINGS

The present invention is illustrated by way of example and is not limited in the figures of the accompanying drawings in which like references indicate similar elements.

FIG. 1 shows a block diagram of an HMM based speech recognition system.

FIG. 2 shows an electronic system which may be used with one embodiment.

FIG. 3 shows an embodiment of a method.

FIG. 4 shows an alternative embodiment of a method.

FIG. 5 shows yet another alternative embodiment of a method.

FIG. 6 shows yet another alternative embodiment of a method.

### DETAILED DESCRIPTION

The following description and drawings are illustrative of the invention and are not to be construed as limiting the invention. Numerous specific details are described to provide a thorough understanding of the present invention. However, in certain instances, well-known or conventional details are not described in order to not unnecessarily obscure the present invention in detail.

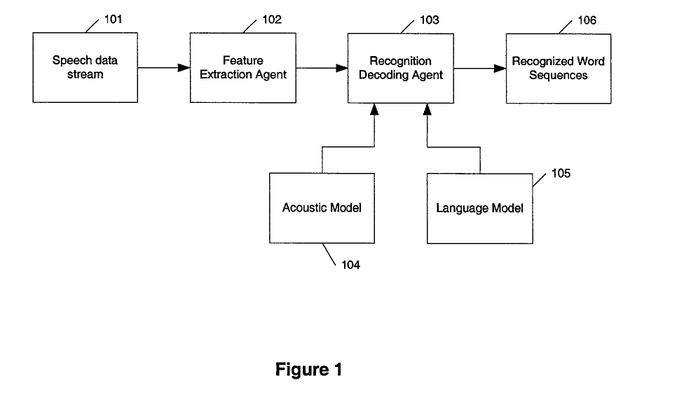

FIG. 1 is a block diagram of a Hidden Markov Model (HMM) based speech recognition system. Typically, the system includes four components: feature extraction agent 102, recognition agent 103, acoustic model 104, and language model 105. In a conventional speech recognition system, each component was independently optimized. For example, feature extraction agent 102 may use linear discriminative analysis (LDA), acoustic model 104 may use maximum-likelihood linear regression (MLLR) and a full covariance transformation (FCT), language model 105 may use a back-off N-gram model, and recognition agent 103 may use various pruning and confidence measures.

LDA is commonly used for feature selection. The basic idea of IDA is to find a linear transformation of feature vectors Xₜ from an n-dimensional space to vectors Yₜ in an m-dimensional space (m<n) such that the class separability is maximized. There are several criteria used to formulate the optimization problem, but the most commonly used is to maximize the following:

J(m)=tr(S_{2y}⁻¹S_{1y}) (Eq. 1)

where tr(A) denotes the trace of A, and S_{my} is the scatter matrix of the m-dimensional y-space. When S₁=B (between-class scatter matrix) and S₂=W (average within-class scatter matrix), the optimization of Eq. 1 results in the input vector Xₜ, which must be projected onto the subspace spanned by the m largest eigenvalues.

In HMM-based systems, the covariance matrix can be either diagonal, block-diagonal, or full. The full covariance matrix case has the advantage over the diagonal case, in which it models interfeature vector element correlation. However, this is at the cost of a greatly increased number of parameters,

$$\frac{n ( n + 3 )}{2} ,$$

as compared to 2n per component in the diagonal case, including the mean vector and covariance matrix, where n is the dimensionality. Due to this increase in the number of parameters, diagonal covariance matrices are commonly used on large vocabulary speech recognition.

FCT is an approximate full covariance matrix. Each covariance matrix is split into two elements, one component-specific diagonal covariance element, A_{diag}^{(m)}, and one component dependent, non-diagonal matrix, U^{(r)}. The form of the approximate full covariance matrix may be as follows:

$${W}_{full}^{( m )} = {U}^{( r )} {Λ}_{diag}^{( m )} {U}^{{( r )}^{T}} \qquad ( Eq . 2 )$$

U^{(r)} may be tied over a set of components, for example, all those associated with the same state of a particular context-independent phone.

So each component, m, has the following parameters: component weight, component mean, μ^{m}, and the diagonal element of the covariance matrix,

$${Λ}_{diag}^{( m )} .$$

In addition, it is associated with a tied class, which has an associated matrix, U^{(r)}. To optimize these parameters directly, rather than dealing with U^{(r)}, it is simpler to deal with its inverse, H^{r}, thus, H^{(r)}=U^{(r)-1}. If a maximum likelihood (ML) estimation of all the parameters is made, the auxiliary function below is normally optimized with respect to H^{(r)}, μ^{(m)} and

$${Λ}_{diag}^{( m )} .$$

$$Q ( M , M ) = {\sum }_{m ∈ {M}^{( r )} , t} {γ}_{m} ( t ) ( log ( \vert {H}^{( r )} {\vert}^{2} ) - log ( \vert diag ( {H}^{( r )} {W}^{( m )} {H}^{{( r )}^{T}} \vert ) ) ) - n β \qquad ( Eq . 3 )$$

where β is the total mixture occupancy. A formula to compute the ML estimates of mean and component specific diagonal covariance matrices can be given as

$$\begin{matrix}{\hat{μ}}^{( m )} = \frac{{\sum }_{t} {γ}_{m} ( t ) {o}_{t}}{{\sum }_{t} {γ}_{m} ( t )} , \\ and & ( Eq . 4 ) \\ {Λ}_{diag}^{( m )} = diag ( {H}^{( r )} {W}^{( m )} {H}^{{( r )}^{T}} ) & ( Eq . 5 )\end{matrix}$$

Given the estimate of μ^{(m)} and Λ_{diag}^{(m)}, optimizing H^{(r)} requires an iterative estimate on a row-by-row basis. The ML estimate for the ith row of H^{(r)}, hᵢ^{(r)}, is given by

$$\begin{matrix}{h}_{i}^{( r )} = {c}_{i} {G}^{{( r , i )}^{- 1}} \sqrt{\frac{β}{{c}_{i} {G}^{{( r , i )}^{- 1}} {c}_{i}^{T}}} \\ where & ( Eq . 6 ) \\ {G}^{( r , i )} = {\sum }_{m ∈ {M}^{( r )}} \frac{1}{{σ}_{diag}^{{( m )}^{2}}} {W}^{( m )} {\sum }_{t} {γ}_{m} ( t ) & ( Eq . 7 )\end{matrix}$$

and cᵢ is the ith row vector of cofactors of the current estimate of H^{(r)} and σ_{diag}^{(m,1)} is the ith diagonal component of the diagonal covariance matrix.

An application of the LDA technology to speech recognition has shown consistent gains for small vocabulary applications. The diagonal modeling assumption that is imposed on the acoustic models in most systems is: if the dimensions of the projected subspace are highly correlated, a diagonal covariance modeling constraint will result in distributions with large overlap and low sample likelihood, and secondly, in the projected subspace the distribution of feature vectors has been changed dramatically, while attempting to model the changed distribution with unchanged model constraints.

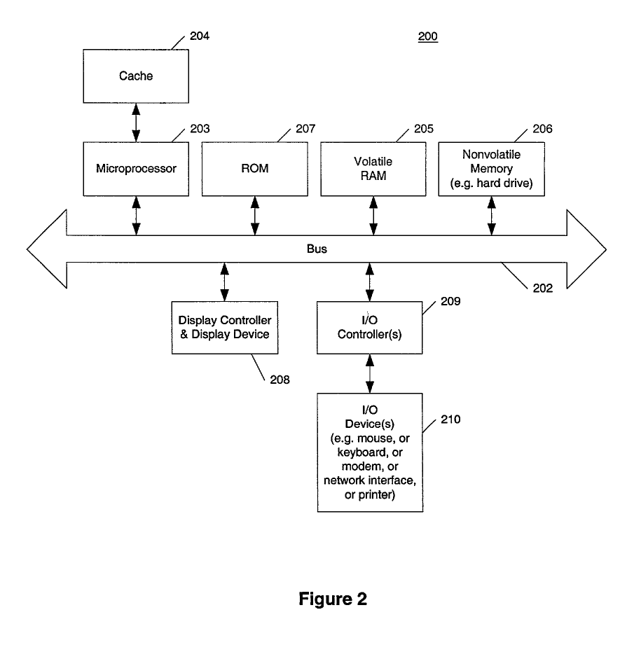

FIG. 2 shows one example of a typical computer system which may be used with one embodiment. Note that while FIG. 2 illustrates various components of a computer system, it is not intended to represent any particular architecture or manner of interconnecting the components, as such details are not germane to the present invention. It will also be appreciated that network computers and other data processing systems which have fewer components or perhaps more components may also be used with the present invention. The computer system of FIG. 2 may, for example, be an Apple Macintosh or an IBM compatible computer.

As shown in FIG. 2, the computer system 200, which is a form of a data processing system, includes a bus 202 which is coupled to a microprocessor 203 and a ROM 207 and volatile RAM 205 and a non-volatile memory 206. The microprocessor 203 is coupled to cache memory 204 as shown in the example of FIG. 2. The bus 202 interconnects these various components together and also interconnects these components 203, 207, 205, and 206 to a display controller and display device 208 and to peripheral devices such as input/output (I/O) devices, which may be mice, keyboards, modems, network interfaces, printers and other devices which are well known in the art. Typically, the input/output devices 210 are coupled to the system through input/output controllers 209. The volatile RAM 205 is typically implemented as dynamic RAM (DRAM) which requires power continuously in order to refresh or maintain the data in the memory. The non-volatile memory 206 is typically a magnetic hard drive, a magnetic optical drive, an optical drive, a DVD RAM, or other type of memory system which maintains data even after power is removed from the system. Typically, the non-volatile memory will also be a random access memory, although this is not required. While FIG. 2 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 202 may include one or more buses connected to each other through various bridges, controllers, and/or adapters, as is well-known in the art. In one embodiment, the I/O controller 209 includes a USB (Universal Serial Bus) adapter for controlling USB peripherals.

The present invention introduces a composite transformation which jointly optimizes the feature space transformation (FST) and model space transformation. Unlike the conventional methods, according to one embodiment, it optimizes the FST and MST jointly and simultaneously, which makes the projected feature space and transformed model space match more closely,.

A typical method to optimize the feature space transformation is through linear discriminant analysis (LDA). Compared with Principal Component Analysis (PCA), LDA is to find a linear transformation which maximizes class separability, namely the covariance for between-class instead of the covariance for whole scatter matrix, such as PCA. The LDA is based on an assumption that the within-class distribution is identical for each class. Further detail concerning LDA analysis can be found on the Web site of http://www.statsoftinc.com/textbooklstdiscan.html. However, LDA is known to be inappropriate for the Hidden Markov Model (HMM) states with unequal sample covariance. Recently the LDA analysis has been extended to heteroscedastic case (HLDA) under maximum likelihood (ML) criteria. Under this standard, the individual weighted contribution of the classes to the objective function of:

$${A}^{*} = {argmax}_{A} \{ - \frac{N}{2} log \vert diag ( {A}_{n - p} {TA}_{n - p}^{T} ) - {\sum }_{j = 1}^{J} \frac{{N}_{j}}{2} log \vert diag ( {A}_{p} {W}_{j} {A}_{p}^{T} ) \vert + N log \vert A \vert \} \qquad ( Eq . 8 )$$

where Aₙ₋ₚ is the matrix whose columns are ordered n-p eigenvectors and Aₚ is the matrix whose columns are the first p eigenvectors. T is the total scatter matrix and Wⱼ is the within-class scatter matrix for state j. Based on the above formula (e.g., Eq. 8), the within-class scatter matrix is different between each state. The first p eigenvectors are used to normalize it and to contribute to the likelihood, while the rest n-p eigenvectors may be ignored for less contribution to the likelihood. It is useful to note that the eigen-space A is considered in the right tem in Eq. 8. Further details concerning HLDA can be found in an article by N. Kumar, “Investigation of Silicon-Auditory Models & Generalization of Linear Discriminant Analysis for Improved Speech Recognition,” Ph.D. thesis, Johns Hopkins University, 1997.

Based on the fact that LDA is invariant to subspace feature space transformation, the present invention introduces an objective function that jointly optimizes the feature space and model space transformation. In one embodiment, the objective function may look like the following:

$$Q ( M , M ) = {\sum }_{m ∈ {M}^{( r )} , t} {γ}_{m} ( t ) ( 2 log ( \vert {H}^{( r )} \vert ) - log ( \vert diag ( {H}^{( r )} {AW}^{( m )} {A}^{T} {H}^{{( r )}^{T}} \vert ) ) ) + βlog \vert {ABA}^{T} \vert \qquad ( Eq . 9 )$$

where A is the feature space transformation and H is the model space transformation. To maximize the above Q function with respect to feature space transformation (A) and model space transformation (H), the composite transformation HA can be achieved by multiplication of A and H. Compared with Eq. 3, it can be seen that the objective function in Eq. 9 extends the ML function in Eq. 3 to include the feature space transformation matrix (e.g., matrix A). If the A is fixed, the Eq. 9 will be equivalent to Eq. 3. If the model space transformation matrix (H) is fixed, it can be seen that Eq. 9 ignores the n-p eigenvectors compared with Eq. 8.

In an alternative embodiment, the feature space transformation (FST) can be optimized through an eigenvalue analysis of a matrix W⁻¹B. In a further alternative embodiment, the FST may be optimized through an objective function, such as Eq. 8. In which case the initial transformation matrix is set to unit matrix. Given the frame alignment of input speech, the objective function of Eq. 8 is optimized using conjugate gradient algorithms to iterative estimate the FST matrix. Thereafter, the model space transformation can be optimized based on the optimized feature space transformation, through an iterative optimization of a procedure. A typical example of such procedure can be found in Mark J. F. Gales, “Semi-Tied Covariance Matrices for Hidden Markov Modes,” IEEE transactions on Speech & Audio Processing, Vol. 7 No. 3, May 1999. For each pair of FST and MST matrixes, the cross-validation decoding is conducted on a development set of speech utterances. If the recognition score compared with the last one becomes smaller, the iteration will be continued, otherwise the iteration will be stopped. The final FST and MST matrixes are received when the iteration process is stopped.

The experiments of an embodiment tested based on a WSJ20K standard test show that the joint optimization provides nearly 10% word error rate reduction, as well as other benefits. The following table shows an example of the result conducted by the invention:

| | Feature Dimension | Word Error on WSJ20K Test (%) |
|---|---|---|
| Baseline | 39 | 11.80 |
| System | | |
| LDA alone | 39 | 12.10 |
| FCT alone | 39 | 11.70 |
| Joint | 39 | 10.80 |
| Optimization | | |

In addition, an embodiment of the invention has been tested in parameter saving and performance improvement, etc. It has proven that more than 25% in parameter size is cut while nearly 10% word error rate reduction has been achieved. The following shows such results under the experiments:

| | Number of Parameters | Word Error Rate |
|---|---|---|
| Baseline/39 | 5690 k | 11.80% |
| Joint Optimizartion/28 | 4105 k | 10.70% |

Experiments on Chinese Large Vocabulary Conversational Speech Recognition (LVCSR) dictation tasks and telephone speech recognition tasks also confirm the similar performance improvement trend.

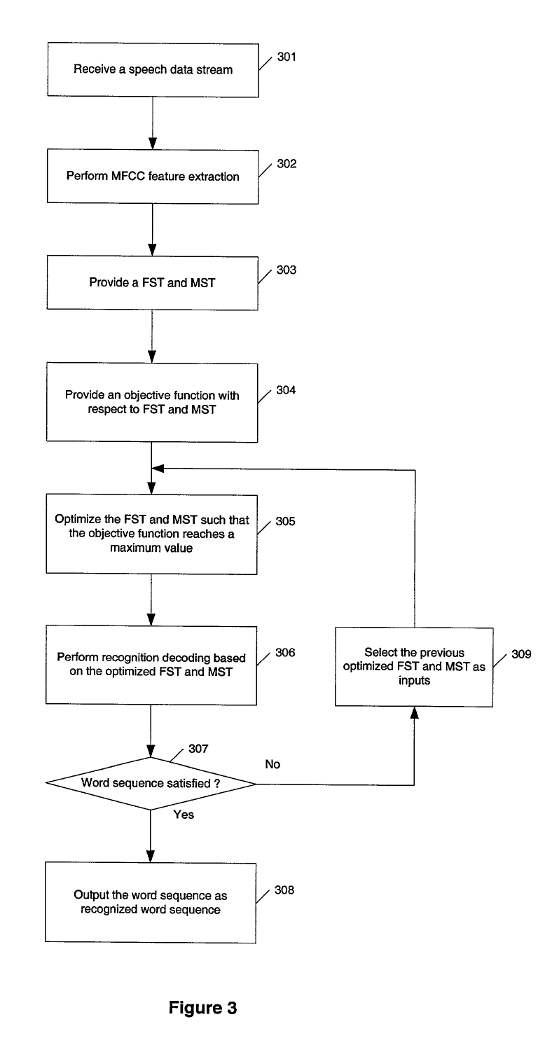

FIG. 3 shows an embodiment of the invention. The method includes providing a first transformation matrix and a second transformation matrix, optimizing the first and second transformation matrices jointly and simultaneously, and generating an output word sequence based on the optimized first and second transformation matrices. The method also provides an objective function with respect to the first and second transformation matrices. The optimizations of the first and second matrices are performed such that the objective function reaches a maximum value.

Referring to FIG. 3, the system receives 301 a speech data stream from an input device and performs 302 an MFCC feature extraction on the speech data stream. MFCC is the most popular acoustic feature used in current speech recognition systems. Compared with Linear Prediction Coefficients (LPC) feature, MFCC is considered with auditory characteristics in terms of logarithm frequency scale and logarithm spectral (Cepstral). The MFCC feature vectors used here include 12 static MFCCs, 12 velocity MFCCs (also called delta coefficients), and 12 acceleration MFCCs (also called delta-delta coefficients). The system 303 uses initial FST and MST and an objective function 304 with respect to the FST and MST. The system then optimizes 305 the objective function. Given an initially fixed MST value, the system searches for an FST such that the objective function reaches a predetermined state. The predetermined state may be a maximum value. In one embodiment, the objective function may comprise:

$$Q ( M , M ) = {\sum }_{m ∈ {M}^{( r )} , t} {γ}_{m} ( t ) ( 2 log ( \vert {H}^{( r )} \vert ) - log ( \vert diag ( {H}^{( r )} {AW}^{( m )} {A}^{T} {H}^{{( r )}^{T}} \vert ) ) ) + βlog \vert {ABA}^{T} \vert$$

The system then performs 306 recognition decoding based on the optimized FST and MST. A word sequence is then generated. However, the word sequence may not be satisfied because the MST and MST may not be optimized to the best state. The word sequence is then checked 307 to determine whether the word sequence is satisfied. If the word sequence is not satisfied, the optimization of FST and MST will be repeated based on the previously optimized FST and MST. Thus, the new optimizations are performed 309 based on the previous optimizations. The optimizations are repeated until the word sequence is satisfied.

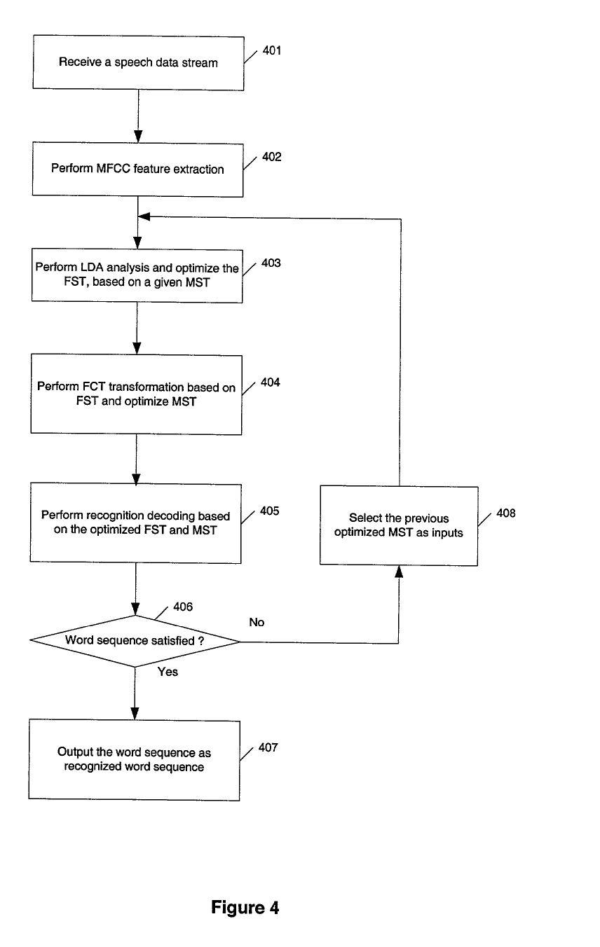

FIG. 4 shows an alternative embodiment of the invention. Referring to FIG. 4, the system receives a speech data stream from an input. The system then performs 402 a Mel Frequency Cepstral Coefficients (MFCC) feature extraction on the speech data stream. Next, the system optimizes 403 the feature space transformation (FST) through a linear discriminant analysis (LDA). During the LDA analysis, the initial model space transformation (MST) may be applied for alignment purposes. Then the system optimizes 404 the MST based on the newly optimized FST. In one embodiment, the optimization of the MST is performed through full covariance transformation (FCT). The MST is optimized based on the FST. Next, both FST and MST are applied 405 to the recognition decoding agent for recognition decoding. As a result, a word sequence is generated. The word sequence is then examined 406 to determine whether the word sequence is satisfied (e.g., the word sequence is recognizable). If the word sequence is not satisfied (e.g., unrecognizable), the optimized MST then is selected 408 as an input and repeats the LDA analysis based on the previously optimized MST. As a result, a new optimized FST is generated and an FCT is performed based on the newly optimized FST, to generate a new optimized MST. The optimizations of the FST and MST are repeated based on the previous optimizations, until the word sequence is satisfied.

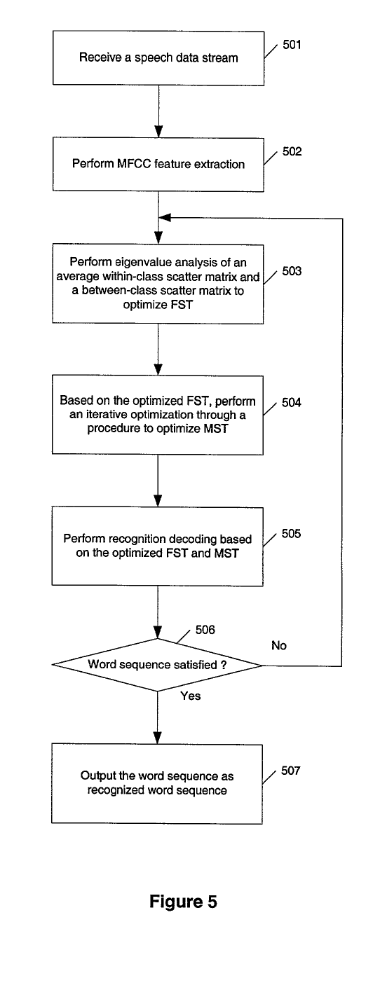

FIG. 5 shows yet another alternative embodiment of the invention. After the speech data stream is received 501, the system conducts 502 a MFCC feature extraction process on the speech data stream. Then the system optimizes 503 the feature space transformation (FST) through an eigenvalue analysis of an average within-class scatter matrix and a between-class scatter matrix. In one embodiment, the optimization of the FST is based on the eigenvalue analysis of W⁻¹B. Next, based on the optimized FST, the system performs 504 an optimization on model space transformation (MST) through an iterative optimization through a procedure, such as one listed by Mark J. F. Gales, “Semi-Tied Covariance Matrices for Hidden Markov Modes,” IEEE transactions on Speech & Audio Processing, Vol. 7 No. 3, May 1999. Thereafter, the optimized FST and MST are inputted 505 to a recognition decoding agent for recognition decoding, generating a word sequence. If the word sequence is not satisfied, the optimizations of FST and MST will be repeated until the word sequence is satisfied, in which case the word sequence is a recognizable word sequence.

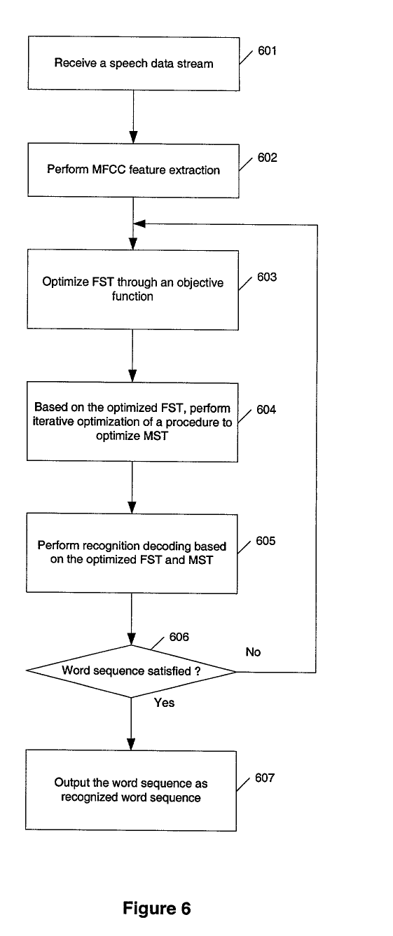

FIG. 6 is yet another alternative embodiment of the invention. Referring to FIG. 6, the optimizations of a feature space transformation (FST) are performed 603 through an objective function with respect to the FST. The objective function may be well-known to one with ordinary skill in the art. In one embodiment, the objective function may be as follows:

$${A}^{*} = {arg max}_{A} \{ - \frac{N}{2} log \vert diag ( {A}_{n - p} {TA}_{n - p}^{T} ) \vert - {\sum }_{J = 1}^{J} \frac{{N}_{j}}{2} log \vert diag ( {A}_{p} {W}_{J} {A}_{p}^{T} ) \vert + N log \vert A \vert \}$$

Based on the optimized FST, the optimization of the MST is performed 604 through an iterative optimization of a procedure. Thereafter, the recognition decoding is performed 605 based on the optimized feature space transformation and model space transformation. A word sequence is generated thereafter. If the word sequence is not satisfied, the optimizations of the FST and MST will be repeated based on the previous optimized FST and MST, until the word sequence is satisfied. Other well-known methods may be used for optimizing the FST, and thereafter the MST is optimized based on the FST.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method, comprising:
receiving a speech data stream;
performing a Mel Frequency Cepstral Coefficients (MFCC) feature extraction on the speech data stream;
optimizing feature space transformation (FST);
optimizing model space transformation (MST) based on the FST; and
performing recognition decoding based on the FST and the MST, generating a word sequence.

2. The method of claim 1, wherein the optimization of the FST is performed through a linear discriminant analysis (LDA), based on an initial MST.

3. The method of claim 1, wherein the optimization of the MST is performed through a full covariance transformation (FCT).

4. The method of claim 1, wherein the optimizations of the FST and the MST are performed jointly and simultaneously.

5. The method of claim 1, wherein the optimizations of the FST and the MST are performed through an objective function with respect to the FST and the MST, such that the objective function reaches a predetermined state.

6. The method of claim 5, wherein the objective function comprises:
$$Q ( M , M ) = {\sum }_{mε {M}^{( r )} , t} {γ}_{m} ( t ) ( 2 log ( \vert {H}^{( r )} \vert ) - log ( \vert diag ( {H}^{( r )} {AW}^{( m )} {A}^{T} {H}^{{( r )}^{T}} ) \vert ) ) + β log \vert {ABA}^{T} \vert$$

7. The method of claim 1, further comprising:
examining the word sequence to determine if the word sequence is satisfied; and
repeating optimization of FST based on the previously optimized MFT, and repeating optimization of MST based on the newly optimized FST, if the word sequence is not satisfied.

8. The method of claim 2, wherein the optimization of the FST is performed through an eigenvalue analysis of a matrix.

9. The method of claim 8, wherein the matrix comprises a matrix of W⁻¹B, wherein the W is the average within-class scatter matrix and the B is the between-class scatter matrix.

10. The method of claim 2, wherein the optimization of the FST is performed through an optimization of an objective function, the objective function comprising:
$${A}^{*} = {arg max}_{A} \{ - \frac{N}{2} log \vert diag ( {A}_{n - p} {TA}_{n - p}^{T} ) \vert - {\sum }_{J = 1}^{J} \frac{{N}_{J}}{2} log \vert diag ( {A}_{p} {W}_{J} {A}_{p}^{T} ) \vert + N log \vert A \vert \}$$

11. The method of claim 3, wherein the optimization of the MST is performed through an iterative optimization of a procedure, based on the FST.

12. A method, comprising:
providing a first transformation matrix;
providing a second transformation matrix;
optimizing the first transformation matrix and the second transformation matrix jointly and simultaneously; and
generating an output based on the first and second optimized matrixes.

13. The method of claim 12, further comprising providing an objective function with respect to the first transformation matrix and the second transformation matrix, the first and second transformation matrixes being jointly and simultaneously optimized, such that the objective function reaches a predetermined state.

14. The method of claim 13, wherein the objective function comprises:
$$Q ( M , M ) = {\sum }_{mε {M}^{( r )} , t} {γ}_{m} ( t ) ( 2 log ( \vert {H}^{( r )} \vert ) - log ( \vert diag ( {H}^{( r )} {AW}^{( m )} {A}^{T} {H}^{{( r )}^{T}} ) \vert ) ) + β log \vert {ABA}^{T} \vert$$

15. The method of claim 12, further comprising:
examining the output to determine if the output is satisfied; and
repeating the optimization of the FST and MST, if the output is not satisfied.

16. A machine readable medium having stored thereon executable code which causes a machine to perform a method, the method comprising:
receiving a speech data stream;
performing a Mel Frequency Cepstral Coefficients (MFCC) feature extraction on the speech data stream;
optimizing feature space transformation (FST);
optimizing model space transformation (MST); and
performing recognition decoding based on the FST and the MST, generating a word sequence.

17. The machine readable medium of claim 16, wherein the optimization of the FST is performed through a linear discriminant analysis (LDA), based on an initial MST.

18. The machine readable medium of claim 16, wherein the optimization of the MST is performed through a full covariance transformation (FCT).

19. The machine readable medium of claim 16, wherein the optimizations of the FST and the MST are performed jointly and simultaneously.

20. The machine readable medium of claim 16, wherein the optimizations of the FST and the MST are performed through an objective function with respect to the FST and the MST, such that the objective function reaches a predetermined state.

21. The machine readable medium of claim 20, wherein the objective function comprises:
$$Q ( M , M ) = {\sum }_{mε {M}^{( r )} , t} {γ}_{m} ( t ) ( 2 log ( \vert {H}^{( r )} \vert ) - log ( \vert diag ( {H}^{( r )} {AW}^{( m )} {A}^{T} {H}^{{( r )}^{T}} ) \vert ) ) + β log \vert {ABA}^{T} \vert$$

22. The machine readable medium of claim 16, further comprising:
examining the word sequence to determine if the word sequence is satisfied; and
repeating optimization of FST based on the previously optimized MFT and repeating optimization of MST based on the newly optimized FST, if the word sequence is not satisfied.

23. A machine readable medium having stored thereon executable code which causes a machine to perform a method, the method comprising:
providing a first transformation matrix;
providing a second transformation matrix;
optimizing the first transformation matrix and the second transformation matrix jointly and simultaneously; and
generating an output based on the first and second optimized matrixes.

24. The machine readable medium of claim 23, wherein the method further comprises providing an objective function with respect to the first transformation matrix and the second transformation matrix, the first and second transformation matrixes being jointly and simultaneously optimized, such that the objective function reaches a predetermined state.

25. The machine readable medium of claim 24, wherein the objective function comprises:
$$Q ( M , M ) = {\sum }_{mε {M}^{( r )} , t} {γ}_{m} ( t ) ( 2 log ( \vert {H}^{( r )} \vert ) - log ( \vert diag ( {H}^{( r )} {AW}^{( m )} {A}^{T} {H}^{{( r )}^{T}} ) \vert ) ) + β log \vert {ABA}^{T} \vert$$

26. The method of claim 23, further comprising:
examining the output to determine if the output is satisfied; and
repeating the optimization of the FST and MST, if the output is not satisfied.

27. A system, comprising:
a first unit to perform a Mel Frequency Cepstral Coefficients (MFCC) feature extraction on a speech data stream;
a second unit to optimize feature space transformation (FST);
a third unit to optimize model space transformation (MST) based on the FST; and
a fourth unit to perform recognition decoding based on the FST and the MST, generating a word sequence.

28. The system of claim 27, wherein the optimizations of the FST and the MST are performed jointly and simultaneously.

29. A system, comprising:
a first unit to provide a first transformation matrix and a second transformation matrix;
a second unit to optimize the first transformation matrix and the second transformation matrix jointly and simultaneously; and
a third unit to generate an output based on the first and second optimized matrixes.

30. The system of claim 29, further comprising providing an objective function with respect to the first transformation matrix and the second transformation matrix, the first and second transformation matrixes being jointly and simultaneously optimized, such that the objective function reaches a predetermined state.
